(19) United States
(12) Patent Application Publication
(10) Pub. No.: US 2006/0236622 A1
(43) Pub. Date: Oct. 26, 2006

(54) STORM PANEL ASSEMBLY

(75) Inventors: Clyde G. Allen, Lapeer, MI (US); Nathan Greenway, Metamora, MI (US); Brad Kutler, Leonard, MI (US); J. Richard Logan, Oxford, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Tapco International Corporation, Wixom, MI (US)

(21) Appl. No.: 11/380,010

(22) Filed: Apr. 25, 2006

Related U.S. Application Data
(60) Provisional application No. 60/674,650, filed on Apr. 25, 2005.

(51) Int. Cl. E06B 3/28

(52) U.S. Cl. 52/203

(57) ABSTRACT

A storm panel assembly mounts on a structure adjacent an opening. The storm panel assembly comprises a frame having a flange for securing the frame to the structure and defines a channel having a locking tab and a first locking surface. A panel having an outer periphery is supported by the frame and a retention portion is disposed adjacent the outer periphery such that the retention portion is received within the channel. A locking insert having a second locking surface for mating with the first locking surface biases the retention portion into contact with the locking tab to secure the panel within the frame.

### CROSS REFERENCE TO RELATED APPLICATION

This application claims the benefit of application Ser. No. 60/674,650 filed Apr. 25, 2005.

### BACKGROUND OF THE INVENTION

1. Field of the Invention

The subject invention relates to a storm panel assembly, and more specifically to a storm panel assembly for providing storm protection, especially hurricane protection, that does not fracture upon impact from debris.

2. Description of the Related Art

Storm panels, e.g., wood or plywood panels may be used to cover or protect windows during severe weather. These storm panels are typically non-decorative and do not allow light into the structure. The panels prevent debris from hitting and breaking the windows. Typically, the panels are large and must be manually fastened to the window frame by screws or nails. The panels are heavy, awkward, and cumbersome to handle. When there is no severe weather, the panel must be stored elsewhere, e.g., a storage shed or garage and must be located, moved, and secured into place prior to a storm. It is cumbersome and time intensive to mount these storm panels as the storm is approaching.

Other related art assemblies incorporate large metal or reinforced vinyl storm panels that are housed in large boxes either above the window or to the side, commonly referred to as accordion or roll down shutters. These metal storm panels are extended when a storm approaches. However, these large boxes are unsightly blemishes on the buildings. The roll down shutters are operated manually, mechanically with a crank or motor, or electronically with a switch or remote control. These shutters are non-decorative, but are self-storing within the boxes. Because the boxes are visible from the outside, many residential communities have “aesthetic compliance codes” and these shutters are banned.

Still other related art references disclose using thermoplastic panels, such as polycarbonate, to cover the openings. These thermoplastic panels may be secured directly to the building. However, the thermoplastic panels have a tendency to fracture or shatter as a result of the thermoplastic panels being rigidly secured to the structure. If the panel is loosely secured to the structure, there is a likelihood that the panel may be torn off during a storm. Additionally, even in light winds, loose panels may vibrate or rattle resulting in undesirable noise being produced.

Therefore, it would be advantageous to provide a storm panel assembly that replaces the related storm panels and that is aesthetically appealing.

### SUMMARY OF THE INVENTION AND ADVANTAGES

The subject invention provides a storm panel assembly for mounting on a structure adjacent an opening. The storm panel assembly comprises a frame having a flange for securing the frame to the structure and defining a channel having a locking tab and a first locking surface. A panel having an outer periphery is supported by the frame and a retention portion is disposed adjacent the outer periphery such that the retention portion is received within the channel. A locking insert having a second locking surface for mating with the first locking surface biases the retention portion into contact with the locking tab to secure the panel within the frame.

The subject invention provides storm protection while also improving the aesthetic appearance of the structure. The storm panel assembly is relatively lightweight and can be adapted for various openings and for different structures and allows light to pass therethrough. Further, the subject invention provides the panel being able to absorb the force from debris. The locking insert secures the panel sufficiently to allow for slight play such that when the debris strikes the assembly, the panel is able to flex and repel the debris with limited or reduced fracturing of the panel. Additionally, the panel is sufficiently secured within the frame to reduce and/or prevent the panel from being torn off or from rattling and shaking during a storm.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an environmental front side view of a structure having openings with a storm panel assembly mounted thereto;

FIG. 2 is a front view of the storm panel assembly;

FIG. 3 is an enlarged partial perspective view of a corner of the storm panel assembly;

FIG. 4 is a cross-sectional side view of one embodiment of a frame according to the subject invention;

FIG. 5 is an enlarged side view of the frame shown in FIG. 4;

FIG. 6 is a cross-sectional side view of a locking insert for engaging the frame;

FIGS. 7A-7C are cross-sectional side views of various embodiments of a retention portion;

FIG. 8 is a cross-sectional side view of the locking insert engaging the frame;

FIG. 9 is a cross-sectional side view of the panel being inserted into the frame;

FIG. 10 is a cross-sectional side view of the storm panel assembly having the locking insert engaging the frame and biasing the retention portion into contact with the frame to secure the panel therebetween;

FIG. 11 is a side-view of another embodiment of the locking insert;

FIG. 12 is a cross-sectional side view of another embodiment of the frame;

FIG. 13 is a cross-sectional side view of a mullion frame; and

FIG. 14 is a side view of another embodiment of the locking insert for engaging the frame of FIG. 12.

### DETAILED DESCRIPTION OF THE INVENTION

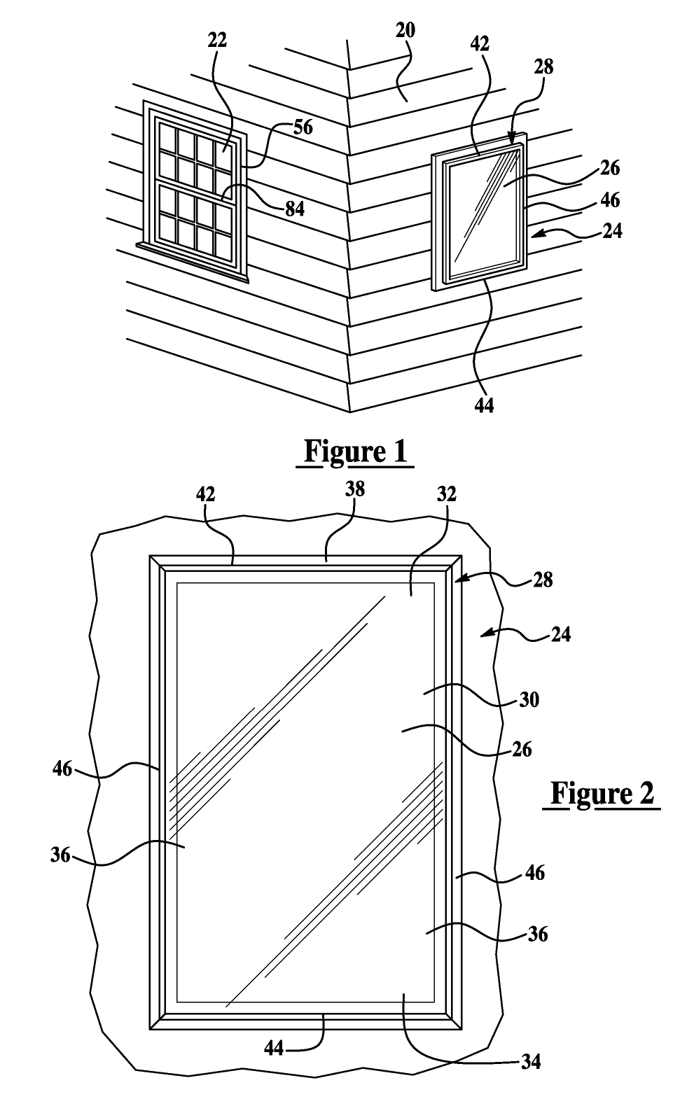

With reference to FIG. 1, an exterior front side view of a structure 20, such as a house, having openings 22 therein, such as windows, is illustrated. A storm panel assembly for storm protection is illustrated generally at 24 as covering one of the openings 22. The storm panel assembly 24 provides storm protection to the opening 22, and more specifically, protects the opening 22 from items, such as debris, hail, water, wind, or the like, in a hurricane or a storm. Debris flying around may contact the storm panel assembly 24 and therefore the storm panel assembly 24 should be able to withstand wind and load forces that may be encountered.

The storm panel assembly 24 comprises a panel 26 and a frame 28 for mounting to the structure 20 and for receiving the panel 26 therein. FIG. 2 illustrates the storm panel assembly 24 mounted to a wall covering an opening 22. The panel 26 has an outer periphery 30 supported by the frame 28. The panel 26 generally includes a top end 32, a bottom end 34, and two vertical sides 36. The panel 26 is selected having a width sufficient such that the opening 22 is covered. Additionally, a plurality of panels 26 may be used to cover larger openings 22 or to provide more protection to the opening 22. It is to be appreciated that the panel 26 may be made of various materials, such as, but not limited to, thermoplastic material, shatterproof glass, film-based materials, reinforced vinyl, or the like. The panel 26 may also be translucent or opaque depending upon the type of material selected. Preferably, the panel 26 is formed from a polycarbonate material that is translucent to allow light to pass therethrough. The panel 26 may be solid, hollow, or hollow with a reinforcing material disposed therein depending upon the desired amount of protection.

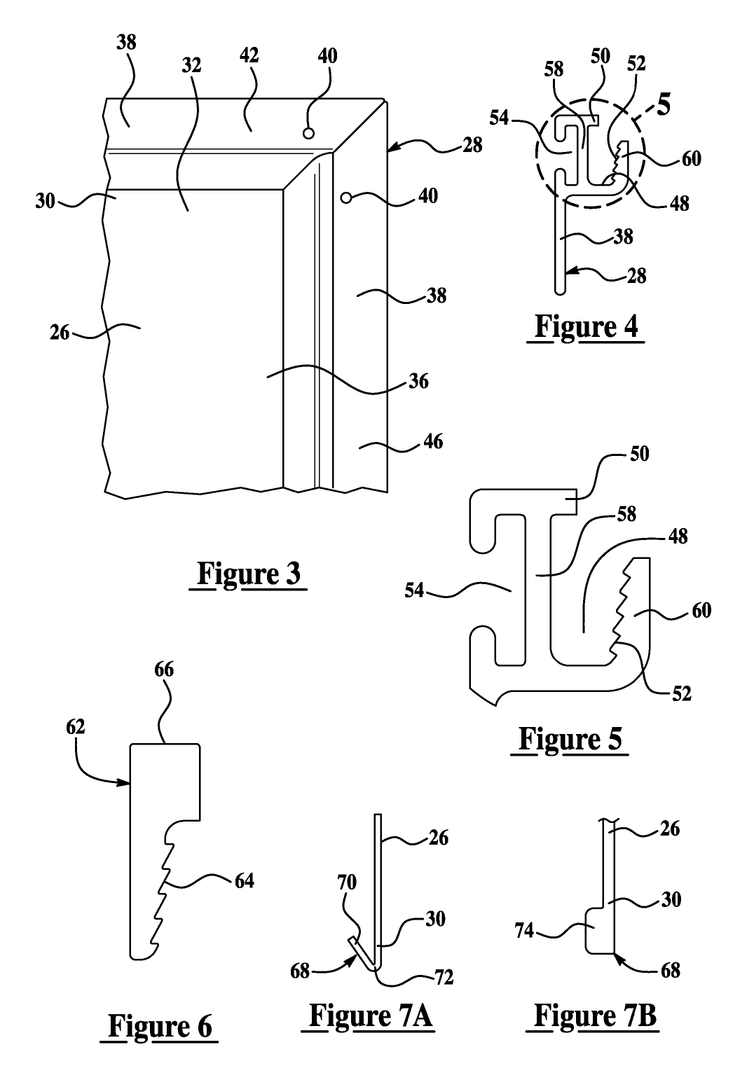

An enlarged view of a corner of the frame 28 is illustrated in FIG. 3. The frame 28 may be mounted to the structure 20 by any means known to those skilled in the art. The frame 28 may include a flange 38 for attaching to the structure 20 defining apertures 40 for receiving fasteners to secure to the structure 20. The frame 28 may include an upper frame 42, a lower frame 44, and vertical frames 46 for surrounding the opening 22. However, it is to be appreciated that differently shaped openings 22 may have different frame configurations.

The frame 28 also defines a channel 48 having a locking tab 50 and a first locking surface 52. The frame 28 also defines a cavity 54 for receiving a decorative molding 56 that surrounds the opening 22. Referring to FIG. 4, as one example, the channel 48 has an inner leg 58 and an outer leg 60. The locking tab 50 extends from either one of the inner and outer legs 58, 60 and the first locking surface 52 is opposite the locking tab 50 on the other inner and outer legs 58, 60. In FIG. 5, the first locking surface 52 is illustrated as being serrated and located on the inner leg 58, while the locking tab 50 is located on the outer leg 60.

Referring to FIG. 6, one embodiment of a locking insert 62 is shown. The locking insert 62 has a second locking surface 64 for mating with the first locking surface 52. In FIG. 6, the second locking surface 64 is shown as being serrated. It is to be appreciated that different configurations of the first and second locking surfaces 52, 64 may be employed so long as a frictional fit therebetween results when in contact with one another. The locking insert 62 may be continuous along each of the sides of the frame 28 or the locking insert 62 may be positioned at separate, discrete points along each of the sides.

The locking insert 62 may also include a striking surface 66 for forcibly wedging the second locking surface 64 into mating engagement with the first locking surface 52. Such an insertion force may be necessary to insert the locking insert 62 into the channel 48. The channel 48 has a width sufficient such that once the locking insert 62 is inserted; the panel 26 has some play to allow for flexing or movement of the panel 26 within the frame 28 without the panel 26 or the locking insert 62 becoming dislodged from the channel 48. When a force is exerted on the panel 26, the panel 26 has some give and the play reduces the likelihood that the panel 26 will shatter when subjected to a force.

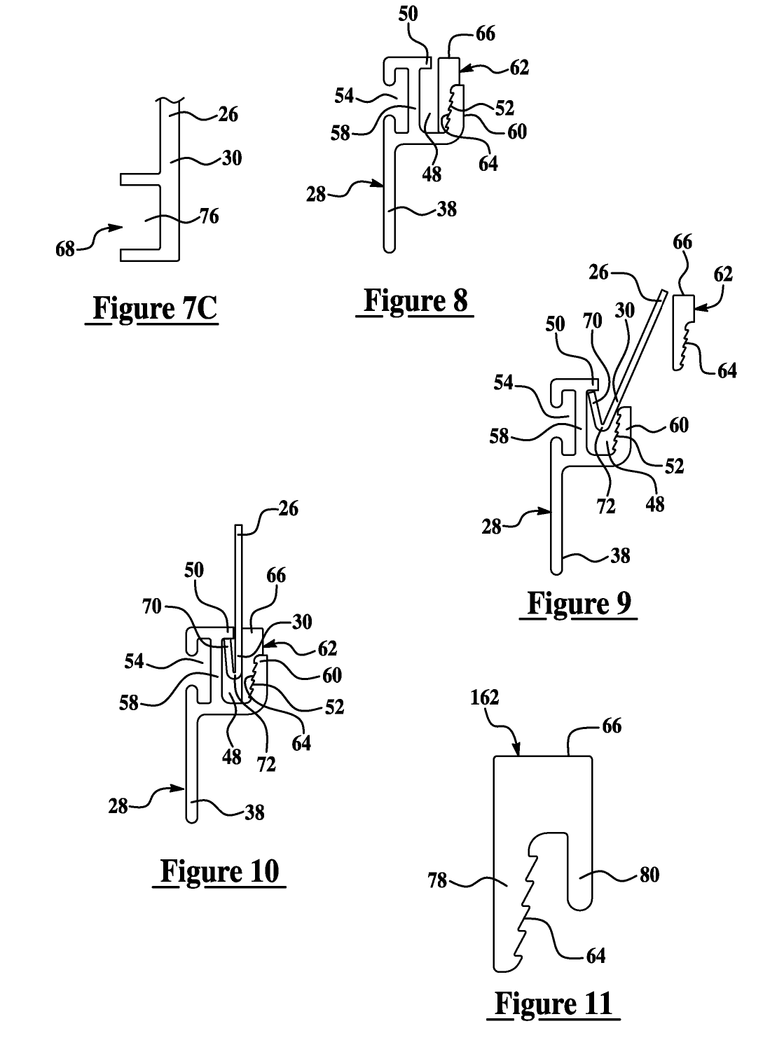

FIGS. 7A-7C illustrate various embodiments of a retention portion, shown generally at 68, disposed adjacent the outer periphery 30 such that the retention portion 68 is received within the channel 48. The locking insert 62, once the first and second locking surfaces 52, 64 are in contact, biases the retention portion 68 into contact with the locking tab 50 to secure the panel 26 within the frame 28. Preferably, the retention portion 68 extends outwardly from a longitudinal plane of the panel 26 to engage the locking tab 50. FIG. 7A illustrates one embodiment of the retention portion 68 as comprising a barb 70 flexibly connected to the outer periphery 30 by a living hinge 72. The barb 70 is able to flex relative to the panel 26 and about the longitudinal plane when biased into contact with the locking tab 50. FIG. 7B illustrates another embodiment of the retention portion 68 as having an enlarged bulb 74 extending from the outer periphery 30 for being biased into contact with the locking tab 50. FIG. 7C illustrates still another embodiment of the retention portion 68 having a recess 76 for engaging the locking tab 50.

Referring to FIG. 8 through, the storm panel assembly 24 is illustrated in various steps resulting in an assembled form. FIG. 8 illustrates the locking insert 62 being in engagement with the frame 28 prior to inserting the panel 26. In FIG. 9, the locking insert 62 is removed and the outer periphery 30 of the panel 26 is illustrated having the retention portion 68 of FIG. 7A positioned in the channel 48. As described above, the barb 70 is flexible to allow the barb 70 to be compressed when the locking insert 62 biases the panel 26 into the channel 48. In FIG. 10, the locking insert 62 has been inserted into the channel 48 such that second locking surface 64 of the locking insert 62 contacts the first locking surface 52 of the outer leg 60. The barb 70 has been compressed by the insertion of the locking insert 62 and is locked into the channel 48 by the engagement of the locking tab 50 with the barb 70. The channel 48 has a sufficient width between the inner and outer legs 58, 60 such that once the locking insert 62 is in place, the panel 26 has some play or movement to dissipate forces that are absorbed by the panel 26.

With reference to FIG. 11, another embodiment of the locking insert 162 is shown having a first leg 78 and a second leg 80, such that the locking insert 162 is generally U-shaped. The second locking surface 64 is further defined as disposed on either one of the first and second legs 78, 80. In FIG. 11, the second locking surface 64 is shown on the first leg 78. Once the locking insert 162 is inserted into the frame 28, the second leg 80 is adjacent the back side of the first locking surface 52 of the outer leg 60 of the channel 48. When a force is absorbed by the panel 26, the second leg 80 of the locking insert 162 limits rotation of the locking insert 162 and prevents the locking insert 162 from disengaging from the channel 48. In this manner, the second leg 80 of the locking insert 162 reduces the likelihood that the locking insert 162 might become dislodged from the channel 48 during a storm.

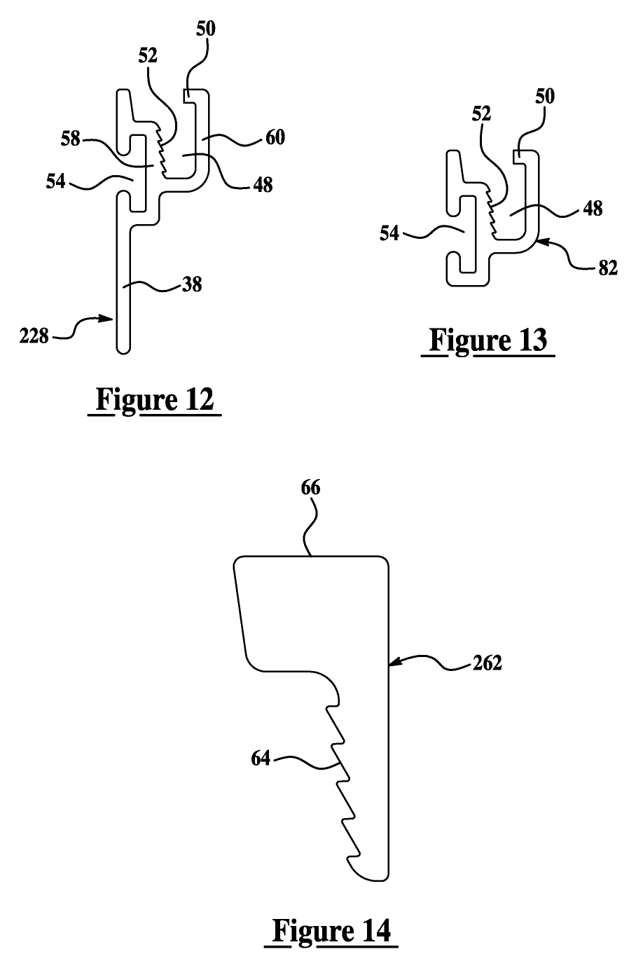

A second embodiment of the subject invention is illustrated in FIGS. 12 through 14. FIG. 12 is a cross-sectional side view of the frame 228 having the first locking surface 52 on the inner leg 58 and the locking tab 50 on the outer leg 60. Further, in the second embodiment, the outer leg 60 extends further than the inner leg 58. FIG. 13 illustrates a mullion frame 82 and FIG. 14 is still another embodiment of the locking insert 262. The locking insert 262 is identical to that of the first embodiment except that the locking insert 262 is a mirror image of FIG. 6. In use, the locking insert 262 would be inserted from inside the storm panel assembly 24, whereas the locking insert 62 shown in FIG. 6 would be inserted from outside the storm panel assembly 24.

Referring again to FIG. 13, a cross-sectional side view of the mullion frame 82 is illustrated. For openings 22 that require multiple panels 26, the mullion frame 82 is attached to the edges of adjacent panels 26 that are aligned. The mullion frame 82 preferably has the same configuration of locking tab 50 and first locking surface 52 as the frame 228. The mullion frame 82 may omit the flange 38 since the mullion frame 82 is holding the two panels 26 together and is not used to secure to the structure 20. The mullion frame 82 may include the cavity 54 for receiving either a decorative mullion molding 84 or adjacent panels 26.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A storm panel assembly for mounting on a structure adjacent an opening, said storm panel assembly comprising:
a frame having a flange for securing said frame to the structure and defining a channel having a locking tab and a first locking surface;
a panel having an outer periphery supported by said frame;
a retention portion disposed adjacent said outer periphery such that said retention portion is received within said channel; and
a locking insert having a second locking surface for mating with said first locking surface to bias said retention portion into contact with said locking tab to secure said panel within said frame.

2. A storm panel assembly as set forth in claim 1 wherein said locking insert further comprises a striking surface for forcibly wedging said second locking surface into mating engagement with said first locking surface.

3. A storm panel assembly as set forth in claim 1 wherein sad first and second locking surfaces are further defined as having a frictional fit therebetween.

4. A storm panel assembly as set forth in claim 3 wherein sad first and second locking surfaces are further defined as serrated.

5. A storm panel assembly as set forth in claim 1 wherein said locking insert is further defined as having a first leg and a second leg.

6. A storm panel assembly as set forth in claim 5 wherein said second locking surface is further defined as disposed on either one of said first and second legs.

7. A storm panel assembly as set forth in claim 1 wherein said retention portion is further defined as extending outwardly from a longitudinal plane of said panel to engage said locking tab.

8. A storm panel assembly as set forth in claim 1 wherein said retention portion further comprises a recess for engaging said locking tab.

9. A storm panel assembly as set forth in claim 1 wherein said retention portion is further defined as a barb flexibly connected to said outer periphery.

10. A storm panel assembly as set forth in claim 9 further comprising a living hinge disposed between said barb and said outer periphery.

11. A storm panel assembly as set forth in claim 1 wherein said channel further comprises an inner leg and an outer leg.

12. A storm panel assembly as set forth in claim 11 wherein said locking tab extends from either one of said inner and outer legs and said first locking surface is opposite said locking tab on said other inner and outer legs.

13. A storm panel assembly as set forth in claim 1 wherein said frame further comprises a cavity for receiving a decorative molding.

14. A storm panel assembly as set forth in claim 1 wherein said frame further comprises an upper frame, a lower frame, and vertical frames for surrounding the opening.

15. A storm panel assembly as set forth in claim 14 further comprising a mullion frame disposed between said upper and lower frames.

16. A storm panel assembly as set forth in claim 15 wherein said mullion frame further comprises a cavity for receiving a decorative mullion molding.

17. A storm panel assembly as set forth in claim 15 further comprising a plurality of panels supported by said upper, lower, and mullions frames for covering the opening.
